(19) United States
(12) Patent Application Publication
(10) Pub. No.: US 2026/0364844 A1
(43) Pub. Date: Nov. 19, 2026

(54) METHODS OF MANUFACTURE OF BIOCIDAL COMPOSITIONS, ARTICLES FOR STORING BIOCIDAL COMPOSITIONS, WOOD PRESERVATIVE SOLUTIONS, AND WOOD PRODUCTS PRODUCED THEREFROM

(71) Applicant: Koppers Performance Chemicals, Inc., Pittsburgh, PA (US)

(72) Inventors: Phi Doan, McDonough, GA (US); Jun Zhang, Peachtree City, GA (US); Douglas Herdman, Peachtree City, GA (US); Michael Smith, Memphis, TN (US)

(21) Appl. No.: 19/487,815

(22) PCT Filed: Jun. 21, 2024
(86) PCT No.: PCT/US2024/034969

§ 371 Date: Nov. 25, 2025

Related U.S. Application Data
(60) Provisional application No. 63/522,462, filed on Jun. 22, 2023.
(60) Provisional application No. 63/536,185, filed on Sep. 1, 2023.

(51) Int. Cl. B27K 3/34; A01N 25/02; A01N 43/80; A01P 3/00

(52) U.S. Cl. CPC B27K 3/343; A01N 25/02; A01N 43/80; A01P 3/00

(57) ABSTRACT

Methods of manufacture of biocidal compositions, articles for storing biocidal compositions, wood preservative solutions, and wood products produced therefrom are provided. The method for manufacturing a biocidal composition includes cooling a heated biocidal composition from a first temperature of at least a melting temperature of the biocidal composition to a second temperature less than the melting temperature to solidify the biocidal composition. The method includes comminuting the biocidal composition into fragments.

### CROSS-REFERENCE

The present application claims priority claims priority to U.S. Provisional Patent Application No. 63/522,462, which was filed on Jun. 22, 2023, and to U.S. Provisional Patent Application No. 63/536,185, which was filed on Sep. 1, 2023. The contents of each is hereby incorporated by reference into this specification.

The present application incorporates International Application PCT/2022/074619, which was filed Aug. 5, 2022, and U.S. Provisional Application No. 63/229,817, which was filed Aug. 5, 2021, by reference herein.

### FIELD

The present disclosure relates to methods of manufacture of biocidal compositions, articles for storing biocidal compositions, wood preservative solutions, and wood products produced therefrom.

### BACKGROUND

Oil-borne preservatives, such as, for example, wood preservative compositions comprising 4,5-dichloro-2-n-octyl-3-isothiazolone or dichlorooctylisothiazolinone (DCOI) can be used to pressure treat wood. Oil-borne preservatives can be manufactured in a concentrate present as waxy/solid form at ambient conditions and then further dissolved in a carrier solvent at higher temperature to produce a treating solution. Efficiently manufacturing and handling of oil-borne preservative concentrate, including transferring a solid form of a concentrate into a solvent, while limiting cross-contamination and/or maintaining safe handling presents challenges.

### SUMMARY

The present disclosure provides a method for manufacturing a biocidal composition. The method comprises cooling a heated biocidal composition from a first temperature of at least a melting temperature of the biocidal composition to a second temperature less than the melting temperature to solidify the biocidal composition. The method comprises comminuting the biocidal composition into fragments.

The present disclosure also provides a method for manufacturing a biocidal composition. The method comprises cooling a heated biocidal composition from a first temperature of at least a melting temperature of the biocidal composition to a second temperature less than the melting temperature to solidify the biocidal composition. The method comprises comminuting the biocidal composition into fragments and disposing a plurality of the fragments into a hydrocarbon solvent dissolvable container. The method comprises combining the hydrocarbon solvent dissolvable container with a hydrocarbon solvent and dissolving the hydrocarbon solvent dissolvable container and the plurality of fragments in the hydrocarbon solvent to form a wood preservative solution.

The present disclosure also provides a wood preservative solution produced by combining a hydrocarbon solvent dissolvable container with a hydrocarbon solvent and dissolving the hydrocarbon solvent dissolvable container and a plurality of fragments of a biocidal composition in the hydrocarbon solvent to form a wood preservative solution. The plurality of fragments of the biocidal composition is produced by a method for manufacturing the biocidal composition. The method comprises cooling a heated biocidal composition from a first temperature of at least a melting temperature of the biocidal composition to a second temperature less than the melting temperature to solidify the biocidal composition. The method comprises comminuting the biocidal composition into fragments.

The present disclosure also provides a method of treating a wood substrate, the method comprising contacting the wood substrate with a wood preservative solution for a period of time suitable to inhibit fungal decay of the wood substrate.

The present disclosure also provides a wood product produced by treating a wood substrate with a wood preservative solution.

The present disclosure also provides a wood product comprising a wood preservative solution.

The present disclosure also provides a method for manufacturing a biocidal composition. The method comprises cooling a heated biocidal composition from a first temperature of at least a melting temperature of the biocidal composition to a second temperature less than the melting temperature to solidify the biocidal composition. The biocidal composition comprises 4,5-dichloro-2-octylisothiazol-3-one (DCOI) and a wax. A weight ratio of the DCOI to the wax is in a range of 1:5 to 5:1. The method comprises flaking the biocidal composition into flakes comprising an aspect ratio of at least 1:2 and an average size of no greater than 50 centimeters. The method comprises disposing a plurality of the flakes into a hydrocarbon solvent dissolvable container.

The present disclosure also provides an article comprising a hydrocarbon solvent dissolvable container defining a cavity therein and a plurality of fragments of a biocidal composition disposed in the cavity.

The present disclosure also provides a method of storing a biocidal composition. The method comprises disposing a plurality of fragments of a biocidal composition in a cavity of a hydrocarbon solvent dissolvable container.

It is understood that the inventions described in this specification are not limited to the examples summarized in this Summary. Various other aspects are described and exemplified herein.

### BRIEF DESCRIPTION OF THE DRAWINGS

The features and advantages of various examples of the present disclosure, and the manner of attaining them, will become more apparent, and the examples will be better understood by reference to the following description of examples taken in conjunction with the accompanying drawing, wherein:

FIG. 1 illustrates a schematic of a drum flaking apparatus configured for a dip feed process according to the present disclosure;

FIG. 2 illustrates a schematic of a drum flaking apparatus configured for a dip roll process according to the present disclosure;

FIG. 3 illustrates a schematic of a drum flaking apparatus configured for an overhead applicator roll process according to the present disclosure;

FIG. 4 illustrates a screw extruder that is equipped with a cooling jacket according to the present disclosure;

FIG. 5 illustrates a schematic of a rotoform system that is configured to form pastilles from a biocidal composition according to the present disclosure;

FIG. 6 illustrates a front perspective view of the rotoform system of FIG. 5;

FIG. 7A illustrates an example of flakes according to the present disclosure;

FIG. 7B illustrates an example of extrudates according to the present disclosure;

FIG. 7C illustrates an example of pellets according to the present disclosure;

FIG. 7D illustrates an example of pastilles according to the present disclosure; and

FIG. 8 illustrates a schematic of an article comprising a hydrocarbon solvent dissolvable container and a plurality of fragments.

Corresponding reference characters indicate corresponding parts throughout the several views. The exemplifications set out herein illustrate certain examples, in one form, and such exemplifications are not to be construed as limiting the scope of the examples in any manner.

### DETAILED DESCRIPTION

Certain exemplary aspects of the present disclosure will now be described to provide an overall understanding of the principles of the structure, function, manufacture, and use of the compositions, methods, and products disclosed herein. One or more examples of these aspects are illustrated in the accompanying drawings. Those of ordinary skill in the art will understand that the devices and methods specifically described herein and illustrated in the accompanying drawings are non-limiting exemplary aspects and that the scope of the various examples of the present disclosure is defined solely by the claims. The features illustrated or described in connection with one exemplary aspect may be combined with the features of other aspects. Such modifications and variations are intended to be included within the scope of the present disclosure.

Any references herein to “various examples,” “some examples,” “one example,” “an example,” similar references to “aspects,” or the like, means that a particular feature, structure, or characteristic described in connection with the example is included in at least one example. Thus, appearances of the phrases “in various examples,” “in some examples,” “in one example,” “in an example,” similar references to “aspects,” or the like, in places throughout the specification are not necessarily all referring to the same example. Furthermore, the particular features, structures, or characteristics may be combined in any suitable manner in one or more examples. Thus, the particular features, structures, or characteristics illustrated or described in connection with one example may be combined, in whole or in part, with the features, structures, or characteristics of one or more other examples without limitation. Such modifications and variations are intended to be included within the scope of the present examples.

4,5-dichloro-2-octylisothiazol-3-one (DCOI) is a waxy solid at ambient temperature and has a melting point in a range of 44 °C to 46 °C. DCOI, with or without additional inert additives, can be used to manufacture DCOI preservative concentrates that can be transported from the facility of manufacture to a treating facility where a wood preservative treating solution is manufactured. Typically, a DCOI preservative concentrate is prepared by heating the components for the concentrate above their melting point and mixing them together to form a uniform product that is in a molten liquid state. The molten liquid concentrate is transferred into a conventional container, such as a drum or a tote. During storage or transportation, the liquid molten concentrate will cool down and form a single piece of waxy solid concentrate at ambient temperature. This single piece of waxy solid concentrate can be challenging to remove from the conventional container. As a result, at the treating facility, prior to being mixed with hydrocarbon solvent carrier to make a wood preservative treating solution, conventional DCOI preservative concentrates may require heating blankets to be placed around/outside the conventional containers, such as drums (e.g., 55 gallon metal drum) or totes, in order to convert the concentrate into liquid form for transfer into dissolution tank. An alternative heating process may be placing the containers inside a hot box so that the DCOI preservative concentrate can be melted into liquid. The heating process can be time intensive (e.g., 24-72 hours). When drums are used, the DCOI preservative concentrate can be removed from drums using a t-bar and high-pressure equipment that can be difficult and lead to cross-contamination as the drum may need to be cleaned and/or properly disposed of.

The present disclosure provides methods of manufacture of biocidal compositions, articles for storing biocidal compositions, wood preservative solutions, and wood products produced therefrom that can enable efficient handling of biocidal compositions and/or manufacture of wood preservative solutions while reducing cross-contamination and maintaining safe handling of the biocidal composition. For example, the fragments of biocidal composition and/or hydrocarbon solvent dissolvable container according to the present disclosure can be easier to move and/or the hydrocarbon solvent dissolvable container can be dissolved into a hydrocarbon solvent along with the biocidal composition to form the wood preservative solution, thereby minimizing, if not eliminating, the need to clean the container used for shipping.

The present disclosure provides a method for manufacturing a biocidal composition. The method comprises cooling a heated biocidal composition from a first temperature of at least a melting temperature of the biocidal composition to a second temperature less than the melting temperature to solidify the biocidal composition. The first temperature can be in a range of 40 degrees Celsius to 200 Degrees Celsius, such as, for example, 40 degrees Celsius to 200 Degrees Celsius, 40 degrees Celsius to 150 degrees Celsius, 40 degrees Celsius to 100 degrees Celsius, 40 degrees Celsius to 90 degrees Celsius, or 40 degrees Celsius to 75 degrees Celsius. When the biocidal composition is at the first temperature, it may be in a liquid or otherwise flowable state.

Cooling to the second temperature can solidify the biocidal composition. As used herein, “solidify” means to increase the viscosity of the biocidal composition such that the biocidal composition is resistant to flow under a moderate stress and tends to retain a definite shape and size. For example, the biocidal composition can be a solid after cooling to the second temperature. The second temperature can be in a range of 0 degrees Celsius to 100 degrees Celsius, such as, for example, 0 degrees Celsius to 40 degrees Celsius, 1 degree Celsius to 50 degrees Celsius, 1 degree Celsius to 30 degrees Celsius, 5 degrees Celsius to 30 degrees Celsius, or 10 degrees Celsius to 30 degrees Celsius.

The method according to the present disclosure comprises comminuting the biocidal composition into fragments. Comminuting the biocidal composition can be performed during cooling the heated biocidal composition, after cooling the heated biocidal composition, or a combination thereof. For example, comminuting may be started during cooling the heated biocidal composition but prior to the biocidal composition reaching the second temperature and the comminuting may continue until and/or after the biocidal composition reaches the second temperature. The comminuting can be started when or after the biocidal composition reaches the second temperature.

The fragments can comprise flakes, extrudates (e.g., triangular rods, rectangular rods, cylindrical rods, hexagonal rods, other rod shapes, tubes), pellets, granules, droplets, pastilles, or a combination thereof. The fragments can comprise an average size (e.g., mean average Feret diameter) of no greater than 50 centimeters (cm), such as, for example, no greater than 40 cm, no greater than 30 cm, no greater than 20 cm, no greater than 10 cm, no greater than 8 cm, no greater than 6 cm, no greater than 5 cm, or no greater than 3 cm. The fragments can comprise a surface area to volume ratio of at least 0.5 cm⁻¹, such as, for example, at least 1 cm⁻¹, at least 2 cm⁻¹, at least 3 cm⁻¹, at least 4 cm⁻¹, at least 5 cm⁻¹, at least 6 cm⁻¹, or at least 10 cm⁻¹. Transforming the biocidal composition into fragments can increase the ease of handling the biocidal composition, the ease of packing the biocidal composition, and/or the dissolvability of the biocidal composition to make a wood preservative solution. For example, the biocidal composition may be easily packed into a container and also have an enhanced surface area to volume ratio suitable for rapid dissolution into a solvent.

Comminuting the biocidal composition can comprise flaking the biocidal composition, granulating the biocidal composition, extruding the biocidal composition, pelletizing the biocidal composition, spraying the biocidal composition, pastillating the biocidal composition, or a combination thereof.

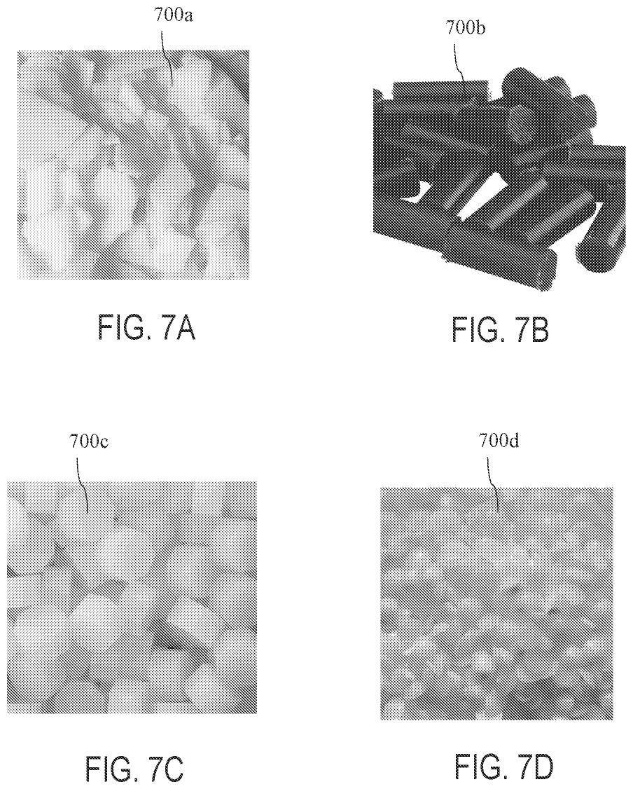

Flaking the biocidal composition can comprise block flaking, drum flaking, or other flaking techniques. For example, drum flaking can comprise applying the biocidal composition to a drum as a layer at a temperature of at least the melting temperature of the biocidal composition. The biocidal composition can be cooled on the drum to a temperature less than the melting temperature to solidify the layer of the biocidal composition. Then, a scraper knife can remove the solidified biocidal composition from the drum to turn the solidified biocidal composition into flakes. The flakes can comprise an aspect ratio (thickness to length) of at least 1:2, such as, for example, at least 1:10. The average thickness of the flakes can be no greater than 3 cm, such as, for example, no greater than 2 cm or no greater than 1 cm. An example of flakes 700a according to the present disclosure is shown in FIG. 7A.

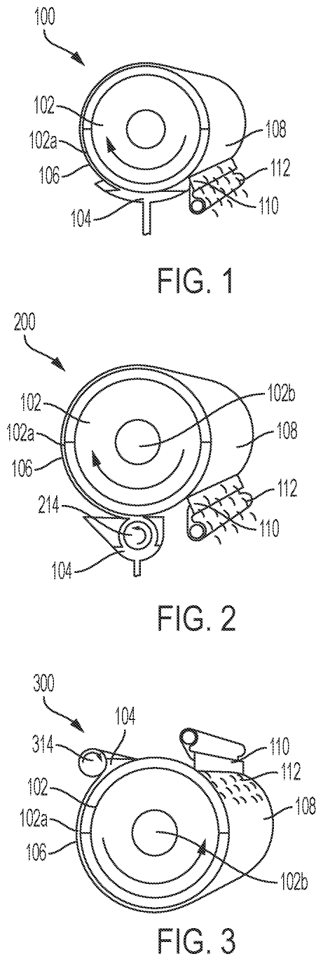

Drum flaking can comprise a dip feed process (e.g., a “k” flaker). For example, as illustrated in FIG. 1, a molten biocidal composition 104 can be applied to a surface 102a of a drum 102 of a drum flaking apparatus 100 as a layer 106 by dipping the surface 102a of the drum 102 in the molten biocidal composition 104 to adhere the molten biocidal composition to the surface 102a of the drum 102. The molten biocidal composition 104 is at a temperature of at least the melting temperature of the molten biocidal composition 104. As the drum 102 rotates, the layer 106 can be cooled on the surface 102a of the drum 102 to a temperature less than the melting temperature to solidify the biocidal composition. The cooling of the drum 102 may be provided internally by circulating a cooling fluid inside of the drum 102. As the rotation of the drum 102 and the layer 106 continues, a scraper knife 110 can remove the solidified portion 108 of the layer 106 from the surface 102a of the drum 102 and break the solidified portion 108 into flakes 112.

Drum flaking can comprise a bottom dip roll process (e.g., a “koo” flaker). For example, as illustrated in FIG. 2, the molten biocidal composition 104 can be being applied to the surface 102a of the drum 102 of a drum flaking apparatus 200 as the layer 106 by a roller 214 rotating in in the molten biocidal composition 104. The roller 214 is position proximal to the surface 102a of the drum 102. The molten biocidal composition 104 is at a temperature of at least the melting temperature of the molten biocidal composition 104. The molten biocidal composition 104 is adhered to the roller 214 and transferred by the roller 214 to the surface 102a of the drum 102. As the drum 102 rotates, the layer 106 can be cooled on the surface 102a of the drum 102 to a temperature less than the melting temperature to solidify the biocidal composition. The cooling of the drum 102 may be provided internally by circulating a cooling fluid inside of the drum 102. As the rotation of the drum 102 and the layer 106 continues, a scraper knife 110 can remove the solidified portion 108 of the layer 106 from the surface 102a of the drum 102 and break the solidified portion 108 into flakes 112.

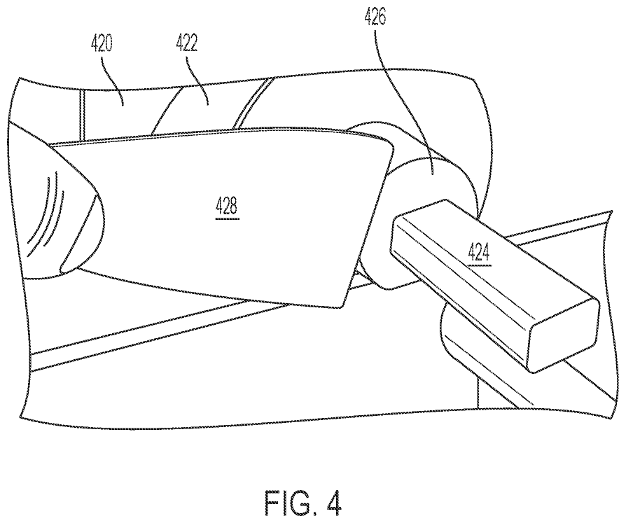

Drum flaking can comprise an overhead applicator roll process (e.g., a “kbo” flaker). For example, as illustrated in FIG. 3, the molten biocidal composition 104 can be being applied to the surface 102a of the drum 102 of a drum flaking apparatus 300 as the layer 106 by a roller 314 coated with the molten biocidal composition 104. The roller 314 is position proximal to the surface 102a of the drum 102. The molten biocidal composition 104 is at a temperature of at least the melting temperature of the molten biocidal composition 104. The molten biocidal composition 104 is adhered to the roller 314 and transferred by the roller 314 to the surface 102a of the drum 102. In FIG. 3 the roller 314 is positioned above a center 102b of the drum 102 as compared to FIG. 2 where the roller 314 is positioned below a center 102b of the drum 102. Referring again to FIG. 3, as the drum 102 rotates, the layer 106 can be cooled on the surface 102a of the drum 102 to a temperature less than the melting temperature to solidify. The cooling of the drum 102 may be provided internally by circulating a cooling fluid inside of the drum 102. As the rotation of the drum 102 and the layer 106 continues, a scraper knife 110 can remove the solidified portion 108 of the layer 106 from the surface 102a of the drum 102 and break the solidified portion 108 into flakes 112.

Granulating the biocidal composition can comprise grinding, crushing, and/or shredding the biocidal composition into granules. For example, the biocidal composition can be fed into a cutting chamber where a series of cutting knives attached to a rotor break the biocidal composition into granules.

Extruding the biocidal composition can comprise passing the biocidal composition through an extrusion die and cutting the extruded biocidal composition into extrudates. For example, the biocidal composition can be heated to a temperature greater than the melting temperature of the biocidal composition and fed into a screw extruder 420 that is equipped with a cooling jacket 422 as illustrated in FIG. 4. The biocidal composition begins to cool in screw extruder 420 and thereby solidify. The solid biocidal composition 424 is then urged through a die 426 under pressure greater than atmospheric and cut with a knife 428 to produce extrudates (not shown in FIG. 4). An example of cylindrical extrudates 700b is shown in FIG. 7B.

Pelletizing the biocidal composition can comprise compressing and/or molding the biocidal composition into the shape of pellets. For example, molten biocidal composition can be passed through a melt cooler heat exchanger to increase the viscosity of the biocidal composition while maintaining the biocidal composition at a temperature greater than the second temperature. Then, the biocidal composition can be introduced to a die cutting chamber and cut into pellets. The die cutting chamber can be flooded and cooled with water, thereby cooling the pellets to a second temperature less than the melting temperature of the biocidal composition. The pellets can be transported by the water into a dryer where the water and the pellets are separated. An example of pellets 700c is shown in FIG. 7C.

Spraying the biocidal composition can comprise passing the biocidal composition through a nozzle under a pressure greater than atmospheric at a temperature greater than the melting temperature of the biocidal composition and forming droplets of the biocidal composition in air and/or on a surface. The droplets of the biocidal composition can be cooled to a second temperature less than the melting temperature of the biocidal composition, thereby solidifying the droplets.

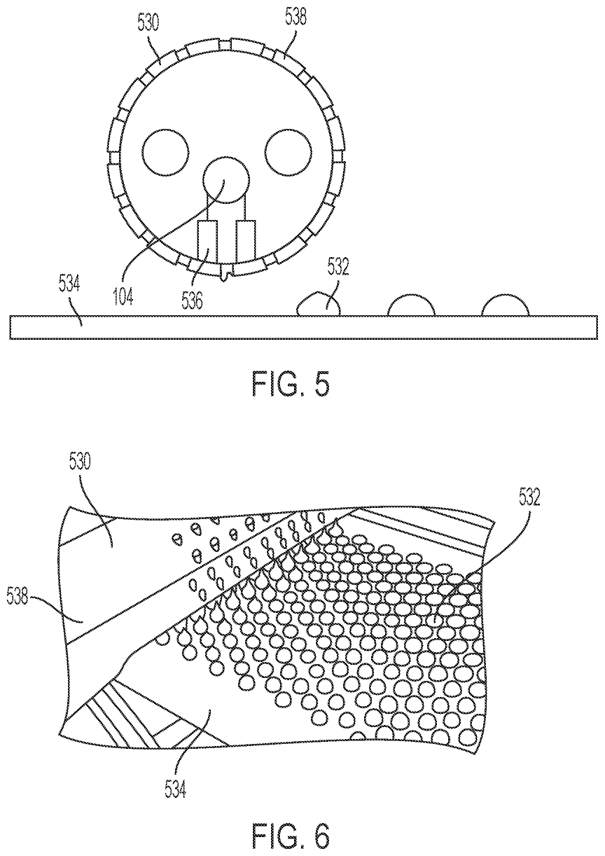

Pastillating the biocidal composition can comprise depositing drops of biocidal composition at a temperature greater than the melting temperature to a belt to form pastilles and cooling the pastilles to a temperature less than the melting temperature of the biocidal composition. For example, referring to FIG. 5 and FIG. 6, the molten biocidal composition 104 can be pumped into a rotoform system 530. The molten biocidal composition 104 can be fed through a metering nozzle bar 536 and a rotating perforated shell 538 of the rotoform system 530 in order to form pastilles 532 on a belt 534. The belt 534 can be cooled internally and can cool the pastilles 532 to the second temperature less than the melting temperature of the biocidal composition. An example of pastilles 700d is shown in FIG. 7D.

The biocidal composition can be a wood preservative biocidal composition. The biocidal composition can be a concentrate for creation of a wood preservative solution. The biocidal composition can comprise a biocide, an additive, and optionally a particle, a filler, a gellant, a polymer, a fiber, a clay mineral, and/or a metal oxide. For example, the biocide can comprise DCOI, pentachlorophenol, bifenthrin, permethrin, propiconazole, tebuconazole, and/or other biocide that is present as a waxy form, semi-solid form or solid form at ambient temperature (e.g., 20 degrees Celsius). The other biocide may comprise a triazole, an imidazole, a pyrazole, a boron compound, a quaternary ammonium, an isothiazolone, a pyrethroid, copper metal, a copper compound (e.g., basic copper carbonate), pentachlorophenol, bethoxazin, or a combination thereof. The biocidal composition may be semi-solid or solid at ambient temperature.

The additive compound can comprise a wax, a polymer, or both a wax and a polymer. The wax can comprise a paraffin wax, an olefin wax, a petroleum wax, a carnauba wax, a polyethylene wax, a slack wax, a silicone wax, a polypropylene wax, a polytetrafluoroethylene (PTFE) synthetic wax, or a combination thereof. The polymer can comprise polyethylene, ethylene-vinyl acetate, or a combination thereof.

The concentration of the additive compound in the biocidal composition can be balanced with the concentration of the biocide in the biocidal composition. For example, a weight ratio of the biocide to the additive compound can be in a range of 1:5 to 5:1, such as, for example, 1:4 to 4:1, 1:3 to 3:1, 1:2 to 2:1, 1.5:1 to 1:1.5, or 1.1:1 to 1:1.1. A weight ratio of the biocide to the additive compound can be 1:1. The biocidal composition can comprise a concentration of a biocide in a range of 10% by weight to 80% by weight based on the total weight of the composition, such as, for example, 20% by weight to 70% by weight, 40% by weight to 60% by weight, or 45% by weight to 55% by weight, all based on the total weight of the solution.

The biocidal composition can comprise a melting temperature and/or softening temperature suitable for handling and/or for a desirable treatment application. For example, the biocidal composition can comprise a melting temperature of at least 40 degrees Celsius, such as, for example, at least 45 degrees Celsius, at least 50 degrees Celsius, at least 55 degrees Celsius, at least 60 degrees Celsius, at least 75 degrees Celsius, or at least 100 degrees Celsius. The biocidal composition can comprise a melting temperature of no greater than 150 degrees Celsius, such as, for example, no greater than 100 degrees Celsius, no greater than 90 degrees Celsius, no greater than 80 degrees Celsius, no greater than 70 degrees Celsius, or no greater than 60 degrees Celsius. For example, the biocidal composition can comprise a melting temperature in a range of 40 degrees Celsius to 150 degrees Celsius, such as, for example, 40 degrees Celsius to 90 degrees Celsius.

After the biocidal composition has been comminuted into fragments, a plurality of the fragments can be disposed into a container to form an article. The container may be a hydrocarbon dissolvable container a supersack bag, a gaylord box, a drum, a tote, and/or other storage container. For example, the container may be a hydrocarbon dissolvable container and placed inside of secondary packaging, such as, for example, a supersack, a gaylord box, a drum, a tote, and/or other storage container. The hydrocarbon solvent dissolvable container can enable efficient handling of the fragments of the wood preservative compositions while reducing cross-contamination and maintaining safe handling of the wood preservative composition during handling. The secondary packaging of a supersack, a gaylord box, a drum, a tote, and/or other storage container can enable efficient handling of the fragments of the wood preservative composition during transport and storage.

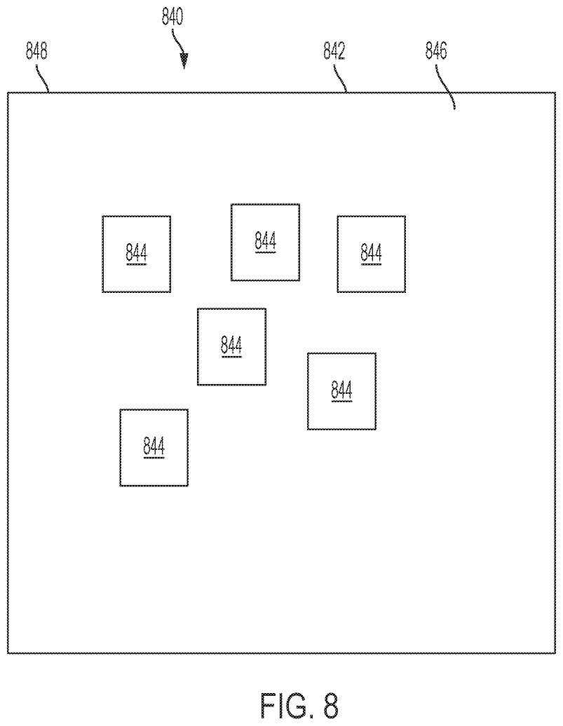

An example of an article 840 comprising a hydrocarbon solvent dissolvable container 842 and a plurality of fragments 844 of a biocidal composition disposed in a cavity 846 of the hydrocarbon solvent dissolvable container 842 are shown in FIG. 8. The hydrocarbon solvent dissolvable container 842 can comprise various shapes, such as, for example, a hollow bag defining the cavity 846 therein or other shape (not shown). The cavity 846 can be filled with the fragments 844 of the biocidal composition and the hydrocarbon solvent dissolvable container 842 can be sealed (e.g., heat sealed) to maintain the fragments of the biocidal composition therein. The hydrocarbon solvent dissolvable container 842 can surround the fragments 844 of the biocidal composition such that handling of the hydrocarbon solvent dissolvable container 842 limits, or prevents, contact with the biocidal composition.

The article 840 may comprise secondary packaging 850. For example, the hydrocarbon solvent dissolvable container 842 can be disposed in a cavity 852 of the secondary packaging 850 as shown in FIG. 8. The secondary packaging 850 can comprise various shapes. The secondary packaging 850 can inhibit damage to the hydrocarbon packaging 850. The secondary packaging 850 can comprise a supersack, a gaylord box, a drum, a tote, and/or other storage container.

The film thickness of the hydrocarbon solvent dissolvable container 842 can be adjusted based on the desired resistance to breakage of the hydrocarbon solvent dissolvable container 842 and time to dissolve the hydrocarbon solvent dissolvable container 842 in a hydrocarbon solvent. The film thickness of a wall 848 of the hydrocarbon solvent dissolvable container 842 can be in a range of 0.1 mil (one thousandth of an inch) to 100 mil, such as, for example, 1 mil to 50 mils, 1 mil to 20 mils, 1 mil to 10 mils, 2 mils to 8 mils, or 4 mils to 8 mils. The hydrocarbon solvent dissolvable container 842 can be covered and/or placed in a supersack bag, a gaylord box, a drum, a tote, and/or other storage container.

The hydrocarbon solvent dissolvable container 842 can comprise a thermoplastic polymer that is dissolvable in hydrocarbon solvents at various temperatures, such as at ambient temperature and/or a temperature greater than ambient temperature. Suitable dissolution temperatures include, for example, a temperature in a range of 20 °C to 200 °C, such as, for example, 30 °C to 150 °C or 40 °C to 100 °C. The thermoplastic polymer can comprise desirable mechanical and/or chemical properties at cold and elevated temperatures. For example, the thermoplastic polymer can comprise at least one of the following properties:
a. A tensile strength or modulus in a range of 10 psi to 100,000 psi;
b. An elongation at break in a range of 10% to 10,000%;
c. A dart impact strength in a range of 1 g to 5000 g;
d. A durometer hardness Shore 00 in a range of 0 to 100;
e. A durometer hardness Shore D in a range of 0 to 100;
f. A melt index in a range of 0.1 g/10 min to 5000 g/10 min;
g. A molecular weight in a range of 1,000 to 10,000,000 g/mol;
h. A polydispersity index (PDI) in a range of 0.1 to 20;
i. A density in a range of 0.6 to 1 g/cm³;
j. A melt viscosity in a range of 1 to 100,000,000 cst;
k. Stable at a temperature in a range of −20 °C to 80 °C;
l. A softening or melting point in a range of 25 °C to 300 °C;
m. Resistance to water;
n. Resistance to select organic solvents, such as, for example, alcohols and acetone;
o. Extrudability;
p. Compatibility with the wood preservative composition; and
q. Dual functionality to provide protection to the wood preservative composition during handling and water repellency to wood after treating the wood with the wood preservative solution.

The thermoplastic polymer can comprise an ethylene-vinyl acetate (EVA) based copolymer. The EVA copolymer may comprise a content of vinyl acetate in a range of 1 wt % to 99 wt % vinyl acetate and/or a content of ethylene in a range of 1 wt % to 99 wt %. For example, the EVA copolymer may comprise a content of vinyl acetage in a range of 1 wt % to 50 wt % vinyl acetate, such as, for example, 1 wt % to 40 wt %, 2 wt % to 40 wt %, 5 wt % to 30 wt %, 5 wt % to 25 wt %, or 8.5 wt % to 18.5 wt % vinyl acetate. The EVA copolymer can contain other monomers in the polymer chain such as, for example, acrylic acid, acrylates, vinyl chloride, styrene, and/or acrylonitrile. The EVA copolymer can comprise ELEVATE® EVA, ELVAX™ EVA, Escorene™ EVA, ATEVA® EVA, Primeva® EVA, A-CR EVA, and/or other EVA copolymers. EVA copolymers can be manufactured into the hydrocarbon solvent dissolvable container 842 by extrusion into bags. The bags can be filled with fragments 844 of the biocidal composition and heat sealed to contain the fragments 844.

The hydrocarbon solvent dissolvable container 842 can include additional ingredients, such as, for example, a filler ingredient and/or a polymer stabilizer. The filler ingredient can comprise calcium carbonate, talc, diatomaceous earth, fly ash, kaolin, and/or mica. The polymer stabilizer can comprise a UV absorber, a light stabilizer, a heat stabilizer, a quencher, an acid scavenger, a metal deactivator, and/or an antioxidant. The biocidal composition may not be in fragments and may be placed in the hydrocarbon dissolvable container in a single piece.

The hydrocarbon solvent dissolvable container can be combined with a hydrocarbon solvent. The hydrocarbon solvent dissolvable container and the plurality of fragments in the hydrocarbon solvent (or singular piece) can be dissolved in the hydrocarbon solvent to form a wood preservative solution. The hydrocarbon solvent can facilitate solubilization of the biocide and/or hydrocarbon solvent dissolvable container and/or the penetration of the biocide into a wood product. For example, the biocide can comprise a solubility of 2% in the hydrocarbon solvent, such as, for example, at least 5% in the hydrocarbon solvent. The hydrocarbon solvent can comprise one solvent, or a mixture of two or more solvents based on the application and/or desired properties of the hydrocarbon solvent.

The concentration of the biocide in the wood preservative solution according to the present disclosure can be selected based on the desired level of inhibition of the fungal decay and/or insect attack, and/or based on the method used to treat the wood product. For example, the wood preservation solution according to the present disclosure can comprise a concentration of a biocide of at least 0.5% by weight based on the total weight of the solution, such as, for example, at least 1.0% by weight, at least 2.0% by weight, at least 2.5% by weight, or at least 3.0% by weight, all based on the total weight of the solution. The wood preservation solution according to the present disclosure can comprise a concentration of a biocide no greater than 10% by weight based on the total weight of the solution, such as, for example, no greater than 9% by weight, no greater than 8% by weight, no greater than 5% by weight, no greater than 4% by weight, or no greater than 3% by weight, all based on the total weight of the solution. The wood preservative solution according to the present disclosure can comprise a concentration of a biocide in a range of 0.5% by weight to 10% by weight based on the total weight of the solution, such as, for example, 1.0% by weight to 5.0% by weight, 1.5% by weight to 5.0% by weight, 1.5% by weight to 3.0% by weight, 2.0% by weight to 3.0% by weight, 2.0% by weight to 2.5% by weight, 1.5% by weight to 2.0% by weight, all based on the total weight of the solution. For example, the wood preservative solution according to the present disclosure can comprise 2% by weight of a biocide based on the total weight of the solution.

When employed in wood preservative solutions according to the present disclosure the hydrocarbon solvent can comprise various hydrocarbon classes and chain lengths. For example, the hydrocarbon solvent can be a hydrocarbon solvent as defined in American Wood Protection Association (AWPA) 2022 Book of Standards HSA-18, HSC-17, HSF-17, HSG-18, HSH-18, or a combination thereof. The chain length and hydrocarbon classes of the hydrocarbon solvents suitable for use with the present disclosure can be selected to achieve a desired flash point of the composition and/or solubility of the biocide. The hydrocarbon solvent can be derived from petroleum-based products, which are generally divided into four groups: (1) paraffins, (2) olefins, (3) naphthenes, and (4) aromatics. Among these groups, paraffins, olefins, and naphthenes are typically called aliphatic solvents. The hydrocarbon solvent can comprise diesel (e.g., diesel #2, diesel #4, diesel #6), biodiesel, vegetable oil, petroleum distillate hydrocarbons, hydro-treated petroleum distillates, hydro-treated paraffinic, hydro-treated naphthenic, synthetic hydrocarbons, and/or an aliphatic solvent.

Biodiesel refers to a vegetable oil- or animal fat-based diesel fuel comprising long-chain alkyl (methyl, ethyl, or propyl) esters. Biodiesel is typically made by chemically reacting lipids (e.g., vegetable oil, soybean oil, animal fat (tallow)) with an alcohol producing fatty acid esters.

The vegetable oil can comprise linseed oil, coconut oil, corn oil, cottonseed oil, palm oil, canola oil, palm kernel oil, olive oil, peanut oil, rapeseed oil, safflower oil, sesame oil, soybean oil, sunflower oil, castor oil, tung oil, poppyseed oil, vernonia oil, almond oil, beech nut oil, Brazil nut oil, virgin oil, cashew oil, hazelnut oil, macadamia oil, mongongo nut oil (manketti oil), pecan oil, pine nut oil, pistachio oil, walnut oil, pumpkin seed oil, pracaxi oil, grape seed oil, rice bran oil, carapa oil, hempseed oil, or a combination thereof.

The aliphatic solvent can comprise, Heptane, Hexane, Kerosene, Lacquer Diluent, Mineral Seal Oil, #2 fuel oil, Mineral Spirits, n-Pentane, OMS-Odorless Mineral Spirits, Rubber Solvent, 140 Solvent, 360 Solvent, Textile Spirits®, VM&P, or a combination thereof.

The hydrocarbon solvent can comprise a flash point of at least 20 degrees Celsius, such as, for example, at least 30 degrees Celsius, at least 40 degrees Celsius, at least 50 degrees Celsius, at least 60 degrees Celsius, at least 70 degrees Celsius, at least 80 degrees Celsius, at least 100 degrees Celsius, at least 150 degrees Celsius, or at least 200 degrees Celsius.

The wood preservative solution can comprise a concentration of the hydrocarbon solvent of at least 50% by weight based on the total weight of the solution, such as, for example, at least 60% by weight, at least 70% by weight, at least 80% by weight, or at least 90% by weight, all based on the total weight of the solution. The wood preservative solution can comprise a concentration of the hydrocarbon solvent in a range of 50% by weight to 99% by weight based on the total weight of the solution, such as, for example, 50% by weight to 98% by weight, 60% by weight to 98% by weight, 70% by weight to 98% by weight, or 80% by weight to 96% by weight, all based on the total weight of the solution.

The wood preservative solution can be used to treat a wood substrate to produce a wood product. For example, the wood preservative solution can be contacted with a wood substrate for a period of time to inhibit fungal decay of the wood substrate. For example, the contacting may comprise vacuum/pressure treating a wood substrate through a modified full-cell process and/or an empty-cell process. For example, the empty-cell process can comprise a Rueping process and a Lowry process. After the process, the wood product may comprise the wood preservative solution. For example, the wood product may comprise at least 0.05 pounds of biocide per cubic foot of the wood product.

The wood product can comprise timber, plywood, laminated veneer lumber (LVL), cross laminated timber (CTL), parallel strand lumber (PSL), structural glued laminated timber, particle board, dimensional lumber, wood poles, or a combination thereof. The wood product can comprise a deck, a rail, a fence, a utility pole, a cross-arm, a pile, a railway tie, a railroad bridge, cladding, siding, or a combination thereof. The wood product can comprise southern pine, Douglas fir, Jack pine, red pine, Lodgepole pine, radiata pine, Alaska yellow cedar, Hem-fir, Nordic pine, Scotts pine, white spruce, Spruce-Pine-Fir, redwood, white oak, red oak, maple, black and red gum, Norway spruce, Sitka spruce, western red cedar, western larch, ponderosa pine, or a combination thereof.

### Examples

The present disclosure will be more fully understood by reference to the following examples, which provide illustrative non-limiting aspects of the present disclosure. It is understood that the present disclosure is not necessarily limited to the examples described in this section.

### Solubility of Ethylene-Vinyl Acetate (EVA, Also Known as Poly(Ethylene-Vinyl Acetate) In Hydrocarbon Solvents:

EVA resin, a material used to make the dissolvable container according to the present disclosure, was placed into solvent at a 5% solution by weight. The solution was stored at 185-190 °F for 24 hours while agitating periodically. Complete solubility of EVA was confirmed by a transparent appearance with no opaqueness. EVA solubility was examined in diesel, biodiesel, petroleum distillate hydrocarbons, and synthetic hydrocarbons. Elevate 502 and 508 manufactured by Westlake Corporation were evaluated. Additionally, A-C 400 and 405M manufactured by Honeywell were evaluated. The solubility of each EVA grade in various solvents is summarized in Table 1.

TABLE 1
Solubility of EVA in various organic solvents.

| | | Elevate 502 | Elevate 508 | A-C 400 | A-C 405M |
|---|---|---|---|---|---|
| | | (12.5% Vinyl | (18.5% Vinyl | (13.0% Vinyl | (8.5% Vinyl |
| CAS # | Solvent | Acetate) | Acetate) | Acetate) | Acetate) |
| 64742-52-5 | Ergon Hyprene 100 | + | + | + | + |
| 64742-47-8 | Univar Low Odor Solvent | + | + | + | + |
| 64742-46-7 | Resolute MaxSolv H-250 | + | + | + | + |
| 64742-53-6 | Resolute MaxNap 40 | + | + | + | + |
| 64742-55-8 | Resolute MaxPar G2 70 | + | + | + | + |
| 876065-86-0 | Sasol HF1000 | + | + | + | + |
| 64742-47-8 | Sasol LPA210 | + | + | + | + |
| 68334-30-5 | No. 2 offroad diesel | + | + | + | + |
| 67784-80-9 | Biodiesel | + | + | + | + |

Compatibility Testing of EVA with DCOI

A 50/50 blend of DCOI/slack wax was prepared by mixing 800 g of slack wax in a water bath set at 80 °C. 800 g of DCOI was melted in a water bath set at 60 °C. DCOI was added to the vessel of slack wax while mixing. The solution was allowed to mix for 15 min. The mixture was poured into a silicone molding to produce 1.5×1.5×1 cm cubes. The cubes were allowed to cool at ambient temperature overnight produce a solid waxy preservative.

4, 5, and 6 mil films of EVA resin were extruded for Elevate 502 and 508. 4×5 inch bags were prepared by using a heat sealer. 125 g of DCOI/wax was added to each bag then sealed. The bags containing the DCOI/wax blend were stored at ambient temperature and 120 °F. The packaging was examined to determine if the preservative concentrate caused packaging degradation or incompatibility issues. The results indicated that there is no compatibility issues between DCOI and the bag made from EVA resin, and there is no structural degradation of the packaging.

### Pastillation of Solid DCOI

A 50/50 blend of DCOI/paraffin wax was prepared by mixing 246 lbs. of molten paraffin wax at 80 °C and 254 lbs. of molten DCOI (98.5% purity). DCOI was added to the vessel of paraffin wax while mixing. The solution was allowed to mix for 1 hour. The liquid mixture was then run through a Rotoform pastillation system. The Rotoform pastillation system consists of a heated cylindrical stator which is supplied with molten product and a perforated rotating shell that turns concentrically around the stator, depositing drops of the product across the whole operating width of the steel cooling belt. The Rotoform pastillation system transforms molten product into uniformly sized pastilles. A pump transports the molten product from a storage vessel to the Rotoform system via heated pipes, ensuring the material remains in a liquid state. The water-cooled belt measured 10 m in length and 600 mm in width. Pastilles acceptable for packaging, transportation and handling were produced at a feed temperature of 80 °C, a discharge temperature of 28 °C, a cooling time of 27 minutes, and a final cooling temperature of 15 °C. Pastilles produced by this process measured 5.6 mm×1.5 mm (Diameter×height).

Approximately 200 lbs. of the solid pastilles produced from the above example were placed in a 2 mil Lomel 180 EVA resin bag (18% vinyl acetate). The bag was sealed using a heat-sealer. The pastille-filled EVA bag was placed inside of a woven polypropylene super sack and sealed. The bag was then shipped to a commercial wood pole treating facility. Prior to removing the bag contents, the packaging was examined to determine if the preservative concentrate caused packaging degradation or incompatibility issues. The results indicated that there was no compatibility issues between the DCOI pastilles and the EVA resin, and there was no structural degradation of the packaging. After inspection, the EVA resin bag filled with pastilles was released from the super sack into a concentrate dissolver tank. This tank contained a prescribed blend of hydrocarbon solvents composed of hydrotreated paraffinic and naphthenic oils. The solution temperature was maintained between 76 °C and 93 °C. Inspection of the dissolver tank after 15 minutes of circulation confirmed that the EVA resin and DCOI pastilles had completely dissolved in the preservative treating solution.

### Cold Form Extrusion of Solid DCOI

A 50/50 blend of DCOI/paraffin wax was prepared by mixing 49 lbs. of molten paraffin wax at 80 °C and 51 lbs. of molten DCOI (98.5% purity). DCOI was added to the vessel of paraffin wax while mixing. The solution was allowed to mix for 1 hour to ensure uniform blending. The molten mixture was cooled while passing through a low-pressure extruder. Low pressure extrusion uses the minimum force needed to produce a dust-free, consistent extrusion with excellent particle integrity and dispersion characteristics. Multiple options exist for extrusion plates, dies, and cut-off knives control particle size and shape. The unit used for this pilot production run cooled to solidify during processing and produced noodle shaped solid DCOI. The extrusion face plate contained multiple round apertures allowing multiple noodles to be produced during the low-pressure extrusion. Noodles were approximately 6-7 mm in diameter and were sheared from the face plate to produce multiple lengths. Noodles were acceptable for packaging, transportation, and handling.

### Prophetic Flaking of Solid DCOI

Producing flakes of solid DCOI preservative can be achieved using multiple processes including drum flaking and belt flaking. The drum flaker transforms a molten product into a solid by cooling it under the solidification temperature. The end product is a flake that is ready for bagging. A heated dip tray under the cooling drum holds the product in its molten state. The cooling drum slowly revolves through the dip tray, and picks up a thin layer of molten product. The product starts to cool and solidify the moment it comes into contact with the cold drum. On the inside, a coolant such as cooling water is accurately sprayed against the drum's inner surface. For belt flaking, the molten product is simply delivered onto the steel belt via feed device, forming a film that is taken up by the running steel belt. This is a similar process to Pastillation but without the Rotoform dispensing head. The steel belt is sprayed on the underside with water from nozzles carefully positioned to ensure uniform cooling, resulting in controlled and even solidification. The heat released during cooling and solidification is eliminated through the steel belt.

### Feasibility of Flaking DCOI

To evaluate the feasibility of flaking solid DCOI, a 50/50 blend of DCOI/slack wax was prepared by mixing 508 grams molten slack wax at 80 °C and 492 grams of molten DCOI (98.5% purity). DCOI was added to the vessel of slack wax while mixing. The solution was allowed to mix for 20 minutes to ensure uniformity. The liquid mixture was then poured onto a cold metal surface that was conditioned to about 10 °C. The liquid DCOI solidified immediately after contacting the cold metal surface and began to cool. The solid material was allowed to cool for 60 seconds at which point it was removed from the metal surface using a doctor blade to simulate the action of a flaker knife chipping solid material off a drum or belt. The solid DCOI was approximately 1 to 2 mm in thickness and was easily broken into flakes that were acceptable for packaging. This evaluation confirmed that flaking technology is a feasible means to produce solid DCOI preservative for package and shipment to commercial treating plants.

Wood Treatability of EVA with DCOI

The introduction of the EVA resin into a DCOI treating solution has the ability to negatively impact solution adsorption into the wood by effectively blocking the wood cellular structure. Such an occurrence would prevent the DCOI preservative from achieving the penetration and retention levels necessary to render the wood protected from the action of wood destroying fungi and insects, such as termites.

A series of DCOI wood treating solutions was prepared to contain EVA resin (Elevate 508 EVA bag). Solutions were prepared by blending 2.3 parts DCOI, 2.3 parts paraffin wax and 0.0, 0.1, 1.0, or 2.5 parts EVA resin. The balance of each formulation was a hydrotreated paraffinic solvent at 95.4, 95.3, 94.4, and 92.9 parts, respectively. Prior to treatment, the treating solutions were heated to a temperature in a range of 88 °C to 93 °C to simulate commercial treating plant procedures. Southern pine boards were then treated using a full-cell treatment cycle of 20 minutes of initial vacuum of −26″Hg followed by 30 minutes of pressure at 120 psi. Boards were weighed before and after treatment to establish solution adsorption. Average solution adsorption for the experimental treatments was 27%, 25%, 23%, and 23%, respectively. These results indicate that treating solution adsorption is not negatively impacted by the presence of the EVA resin in the DCOI treating solutions.

Various aspects of the present disclosure include, but are not limited to, the aspects listed in the following numbered clauses.
Clause 1. A method for manufacturing a biocidal composition, the method comprising: cooling a heated biocidal composition from a first temperature of at least a melting temperature of the biocidal composition to a second temperature less than the melting temperature to solidify the biocidal composition; and comminuting the biocidal composition into fragments.
Clause 2. The method of clause 1, wherein comminuting the biocidal composition is performed during cooling the heated biocidal composition, after cooling the heated biocidal composition, or a combination thereof.
Clause 3. The method of any of clauses 1-2, wherein the first temperature is in a range of 40 degrees Celsius to 200 Degrees Celsius.
Clause 4. The method of any of clauses 1-3, wherein the second temperature is in a range of 0 degrees Celsius to 100 degrees Celsius.
Clause 5. The method of any of clauses 1-4, wherein the melting temperature is in a range of 40 degrees Celsius to 150 degrees Celsius.
Clause 6. The method of any of clauses 1-5, wherein comminuting the biocidal composition comprises flaking the biocidal composition, granulating the biocidal composition, extruding the biocidal composition, pelletizing the biocidal composition, spraying the biocidal composition, pastillating the biocidal composition, or a combination thereof.
Clause 7. The method of any of clauses 1-6, wherein the fragments comprise flakes, extrudates, pellets, granules, droplets, pastilles, or a combination thereof.
Clause 8. The method of any of clauses 1-7, wherein comminuting the biocidal composition comprises flaking the biocidal composition and the fragments comprise flakes.
Clause 9. The method of clause 8, wherein the flakes comprise an aspect ratio of at least 1:2.
Clause 10. The method of any of clauses 8-9, wherein the flakes comprise an aspect ratio of at least 1:10.
Clause 11. The method of any of clauses 1-10, wherein the fragments comprise a surface area to volume ratio of at least 0.5 cm⁻¹.
Clause 12. The method of any of clauses 1-11, wherein the biocidal composition comprises a biocide and an additive, wherein the additive comprises a wax, a polymer, or both a wax and a polymer.
Clause 13. The method of clause 12, wherein a weight ratio of the biocide to the additive is in a range of 1:5 to 5:1.
Clause 14. The method of any of clauses 12-13, wherein a weight ratio of the biocide to the additive is in a range of 1:2 to 2:1.
Clause 15. The method of any of clauses 12-14, wherein the biocide comprises 4,5-dichloro-2-octylisothiazol-3-one, pentachlorophenol, bifenthrin, permethrin, propiconazole, tebuconazole, or a combination thereof.
Clause 16. The method of any of clauses 12-15, wherein the biocide comprises 4,5-dichloro-2-octylisothiazol-3-one.
Clause 17. The method of any of clauses 12-16, wherein the additive comprises the wax and the wax comprises a paraffin wax, an olefin wax, a petroleum wax, a carnauba wax, a polyethylene wax, a slack wax, a silicone wax, a polypropylene wax, a polytetrafluoroethylene synthetic wax, or a combination thereof.
Clause 18. The method of any of clauses 12-17, wherein the additive comprises the polymer and the polymer comprises polyethylene, ethylene-vinyl acetate, or a combination thereof.
Clause 19. The method of any of clauses 1-18, further comprising disposing a plurality of fragments into a hydrocarbon solvent dissolvable container.
Clause 20. The method of clause 19, wherein the hydrocarbon solvent dissolvable container comprises a thermoplastic.
Clause 21. The method of any of clauses 19-20, wherein the hydrocarbon solvent dissolvable container comprises an ethylene-vinyl acetate copolymer.
Clause 22. The method of any of clauses 19-21, wherein the ethylene-vinyl acetate copolymer comprises: a content of vinyl acetate in a range of 1 wt % to 99 wt % vinyl acetate; a content of ethylene in a range of 1 wt % to 99 wt %; or a combination thereof.
Clause 23. The method of any of clauses 19-22, wherein the ethylene-vinyl acetate copolymer comprises a content of vinyl acetate in a range of 5 wt % to 25 wt % vinyl acetate.
Clause 24. The method of any of clauses 19-23, wherein the ethylene-vinyl acetate copolymer comprises a content of vinyl acetate in a range of 8.5 wt % to 18.5 wt % vinyl acetate.
Clause 25. The method of any of clauses 19-24, further comprising: combining the hydrocarbon solvent dissolvable container with a hydrocarbon solvent, and dissolving the hydrocarbon solvent dissolvable container and the plurality of fragments in the hydrocarbon solvent to form a wood preservative solution.
Clause 26. A wood preservative solution formed by the method of clause 25.
Clause 27. A method of treating a wood substrate, the method comprising contacting the wood substrate with the wood preservative solution of clause 26 for a period of time suitable to inhibit fungal decay of the wood substrate.
Clause 28. The method of clause 27, wherein the contacting comprises a modified full-cell process, an empty-cell process, or a combination thereof.
Clause 29. The method of clause 28, wherein the contacting comprises the empty-cell process and the empty-cell process comprises a Rueping process and a Lowry process.
Clause 30. A wood product produced by treating a wood substrate with the wood preservative solution of clause 26.
Clause 31. A wood product comprising the wood preservative solution of clause 26.
Clause 32. The wood product of any of clauses 30-31, wherein the wood product comprises at least 0.05 pounds of biocide per cubic foot of the wood product.
Clause 33. The wood product of any of clauses 30-32, wherein the wood product comprises timber, plywood, laminated veneer lumber (LVL), cross laminated timber (CTL), parallel strand lumber (PSL), structural glued laminated timber, particle board, dimensional lumber, wood poles, or a combination thereof.
Clause 34. The wood product of any of clauses 30-33, wherein the wood product comprises a deck, a rail, a fence, a utility pole, a cross-arm, a pile, a railway tie, a railroad bridge, cladding, siding, or a combination thereof.
Clause 35. The wood product of any of clauses 30-34, wherein the wood product comprises southern pine, Douglas fir, Jack pine, red pine, Lodgepole pine, radiata pine, Alaska yellow cedar, Hem-fir, Nordic pine, Scotts pine, white spruce, Spruce-Pine-Fir, redwood, white oak, red oak, maple, black and red gum, Norway spruce, Sitka spruce, western red cedar, western larch, ponderosa pine, or a combination thereof.
Clause 36. A method for manufacturing a biocidal composition, the method comprising: cooling a heated biocidal composition from a first temperature of at least a melting temperature of the biocidal composition to a second temperature less than the melting temperature to solidify the biocidal composition, wherein the biocidal composition comprises 4,5-dichloro-2-octylisothiazol-3-one (DCOI) and a wax, wherein a weight ratio of the DCOI to the wax is in a range of 1:5 to 5:1; flaking the biocidal composition into flakes comprising an aspect ratio of at least 1:2; and disposing a plurality of flakes into a hydrocarbon solvent dissolvable container.
Clause 37. A hydrocarbon solvent dissolvable container for use with a biocidal composition as provided herein.
Clause 38. A method of storing a biocidal composition using a hydrocarbon solvent dissolvable container as provided herein.
Clause 39. A method of manufacture of a wood preservative solution using a biocidal composition stored in a hydrocarbon solvent dissolvable container as provided herein.
Clause 40. An article comprising: a hydrocarbon solvent dissolvable container defining a cavity therein; and a biocidal composition disposed in the cavity.
Clause 41. The article of clause 40, further comprising secondary packaging defining a cavity therein, wherein the hydrocarbon solvent dissolvable container is disposed in the packaging cavity.
Clause 42. The article of clause 41, wherein the secondary packaging comprises a supersack bag, a gaylord box, a drum, a tote, or a combination thereof.
Clause 43. The article of any of clauses 40-42, wherein the hydrocarbon solvent dissolvable container comprises a thermoplastic.
Clause 44. The article of any of clauses 40-43, wherein the thermoplastic comprises an ethylene-vinyl acetate.
Clause 45. The article of any of clauses 40-44, wherein the ethylene-vinyl acetate copolymer comprises: a content of vinyl acetate in a range of 1 wt % to 99 wt % vinyl acetate; a content of ethylene in a range of 1 wt % to 99 wt %; or a combination thereof.
Clause 46. The article of any of clauses 44-45, wherein the ethylene-vinyl acetate copolymer comprises a content of vinyl acetate in a range of 5 wt % to 25 wt % vinyl acetate.
Clause 47. The article of any of clauses 44-46, wherein the ethylene-vinyl acetate copolymer comprises a content of vinyl acetate in a range of 8.5 wt % to 18.5 wt % vinyl acetate.
Clause 48. The article of any of clauses 40-47, wherein a film thickness of the hydrocarbon solvent dissolvable container is in a range of 0.1 mil to 100 mils.
Clause 49. The article of any of clauses 40-48, wherein the biocidal composition comprises a plurality of fragments.
Clause 50. The article of any of clauses 40-49, wherein the biocidal composition is a single piece.
Clause 51. A method of manufacture of a wood preservative solution, the method comprising: combining the article of any of clauses 40-50 with a hydrocarbon solvent, and dissolving the hydrocarbon solvent dissolvable container and the biocidal composition in the hydrocarbon solvent to form the wood preservative solution.
Clause 52. A method of storing a biocidal composition, the method comprising: disposing a biocidal composition in a cavity of a hydrocarbon solvent dissolvable container.

In this specification, unless otherwise indicated, all numerical parameters are to be understood as being prefaced and modified in all instances by the term “about”, in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Also, any numerical range recited herein includes all sub-ranges subsumed within the recited range. For example, a range of “1 to 10” includes all sub-ranges between (and including) the recited minimum value of 1 and the recited maximum value of 10, that is, having a minimum value equal to or greater than 1 and a maximum value equal to or less than 10. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited.

The grammatical articles “a,” “an,” and “the,” as used herein, are intended to include “at least one” or “one or more,” unless otherwise indicated, even if “at least one” or “one or more” is expressly used in certain instances. Thus, the articles are used herein to refer to one or more than one (i.e., to “at least one”) of the grammatical objects of the article. Further, the use of a singular noun includes the plural, and the use of a plural noun includes the singular, unless the context of the usage requires otherwise.

Any patent, publication, or other disclosure material identified herein is incorporated by reference into this specification in its entirety unless otherwise indicated, but only to the extent that the incorporated material does not conflict with existing descriptions, definitions, statements, or other disclosure material expressly set forth in this specification. As such, and to the extent necessary, the express disclosure as set forth in this specification supersedes any conflicting material incorporated by reference. Any material, or portion thereof, that is said to be incorporated by reference into this specification, but which conflicts with existing definitions, statements, or other disclosure material set forth herein, is only incorporated to the extent that no conflict arises between that incorporated material and the existing disclosure material. Applicants reserve the right to amend this specification to expressly recite any subject matter, or portion thereof, incorporated by reference herein.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

With respect to the appended claims, those skilled in the art will appreciate that recited operations therein may generally be performed in any order. Also, although various operational flows are presented in a sequence(s), it should be understood that the various operations may be performed in other orders than those that are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

One skilled in the art will recognize that the herein-described components, devices, operations/actions, and objects, and the discussion accompanying them, are used as examples for the sake of conceptual clarity and that various configuration modifications are contemplated. Consequently, as used herein, the specific examples/embodiments set forth and the accompanying discussion are intended to be representative of their more general classes. In general, use of any specific exemplar is intended to be representative of its class, and the non-inclusion of specific components, devices, operations/actions, and objects should not be taken limiting. While the present disclosure provides descriptions of various specific aspects for the purpose of illustrating various aspects of the present disclosure and/or its potential applications, it is understood that variations and modifications will occur to those skilled in the art. Accordingly, the present disclosure should be understood to be at least as broad as they are claimed and not as more narrowly defined by particular illustrative aspects provided herein.

1. A method for manufacturing a biocidal composition, the method comprising:
cooling a heated biocidal composition from a first temperature of at least a melting temperature of the biocidal composition to a second temperature less than the melting temperature to solidify the biocidal composition; and
comminuting the biocidal composition into fragments.

2. The method of claim 1, wherein comminuting the biocidal composition is performed during cooling the heated biocidal composition, after cooling the heated biocidal composition, or a combination thereof.

3. The method of claim 1, wherein the first temperature is in a range of 40 degrees Celsius to 200 Degrees Celsius, the second temperature is in a range of 0 degrees Celsius to 100 degrees Celsius, and the melting temperature is in a range of 40 degrees Celsius to 150 degrees Celsius.

4. (canceled)

5. (canceled)

6. The method of claim 1, wherein comminuting the biocidal composition comprises flaking the biocidal composition, granulating the biocidal composition, extruding the biocidal composition, pelletizing the biocidal composition, spraying the biocidal composition, pastillating the biocidal composition, or a combination thereof.

7. The method of claim 1, wherein the fragments comprise flakes, extrudates, pellets, granules, droplets, pastilles, or a combination thereof.

8. The method of claim 1, wherein comminuting the biocidal composition comprises flaking the biocidal composition and the fragments comprise flakes.

9. The method of claim 8, wherein the flakes comprise an aspect ratio of at least 1:2.

10. (canceled)

11. The method of claim 1, wherein the fragments comprise a surface area to volume ratio of at least 0.5 cm⁻¹.

12. The method of claim 1, wherein the biocidal composition comprises a biocide and an additive, wherein the additive comprises a wax, a polymer, or both a wax and a polymer.

13. The method of claim 12, wherein a weight ratio of the biocide to the additive is in a range of 1:5 to 5:1.

14. (canceled)

15. The method of claim 12, wherein the biocide comprises 4,5-dichloro-2-octylisothiazol-3-one, pentachlorophenol, bifenthrin, permethrin, propiconazole, tebuconazole, or a combination thereof.

16. The method of claim 12, wherein the biocide comprises 4,5-dichloro-2-octylisothiazol-3-one.

17. The method of claim 12, wherein the additive comprises the wax and the wax comprises a paraffin wax, an olefin wax, a petroleum wax, a carnauba wax, a polyethylene wax, a slack wax, a silicone wax, a polypropylene wax, a polytetrafluoroethylene synthetic wax, or a combination thereof.

18. The method of claim 12, wherein the additive comprises the polymer and the polymer comprises polyethylene, ethylene-vinyl acetate, or a combination thereof.

19. The method of claim 1, further comprising disposing a plurality of fragments into a hydrocarbon solvent dissolvable container.

20. (canceled)

21. (canceled)

22. The method of claim 18, wherein the ethylene-vinyl acetate copolymer comprises:
a content of vinyl acetate in a range of 1 wt % to 99 wt % vinyl acetate;
a content of ethylene in a range of 1 wt % to 99 wt %; or
a combination thereof.

23. The method of claim 18, wherein the ethylene-vinyl acetate copolymer comprises a content of vinyl acetate in a range of 5 wt % to 25 wt % vinyl acetate.

24. The method of claim 18, wherein the ethylene-vinyl acetate copolymer comprises a content of vinyl acetate in a range of 8.5 wt % to 18.5 wt % vinyl acetate.

25. (canceled)

26. A wood preservative solution formed by dissolving the fragments produced by the method of claim 1 with a hydrocarbon solvent.

27. A method of treating a wood substrate, the method comprising contacting the wood substrate with the wood preservative solution of claim 26 for a period of time suitable to inhibit fungal decay of the wood substrate.

28. (canceled)

29. (canceled)

30. A wood product produced by treating a wood substrate with the wood preservative solution of claim 26.

31. A wood product comprising the wood preservative solution of claim 26.

32. The wood product of claim 31, wherein the wood product comprises at least 0.05 pounds of biocide per cubic foot of the wood product.

33-35. (canceled)

36. A method for manufacturing a biocidal composition, the method comprising:
cooling a heated biocidal composition from a first temperature of at least a melting temperature of the biocidal composition to a second temperature less than the melting temperature to solidify the biocidal composition, wherein the biocidal composition comprises 4,5-dichloro-2-octylisothiazol-3-one (DCOI) and a wax, wherein a weight ratio of the DCOI to the wax is in a range of 1:5 to 5:1;
flaking the biocidal composition into flakes comprising an aspect ratio of at least 1:2 and;
disposing a plurality of flakes into a hydrocarbon solvent dissolvable container.

37-49. (canceled)

50. The method of claim 1, wherein the biocidal composition comprises a biocide.
